(19) United States
(12) Patent Application Publication
(10) Pub. No.: US 2011/0278938 A1
(43) Pub. Date: Nov. 17, 2011

(54) AC BATTERY EMPLOYING MAGISTOR TECHNOLOGY

(75) Inventor: Patrick J. McCleer, Jackson, MI (US)

(73) Assignee: MAGISTOR TECHNOLOGIES, L.L.C., Bloomfield Hills, MI (US)

(21) Appl. No.: 13/103,932

(22) Filed: May 9, 2011

Related U.S. Application Data
(60) Provisional application No. 61/333,779, filed on May 12, 2010.

(51) Int. Cl. H02J 1/10; H02M 5/40

(52) U.S. Cl. 307/82; 363/34

(57) ABSTRACT

A DC/AC converter incorporates at least one Magistor module having a first sp control switch, a second sz control switch and a third sm control switch. An AC source is connected to an input of the at least one Magistor module. A switch controller connected to the first sp control switch, second sz control switch and third sm control switch to and provides pulse width modulation (PWM) activation of the switches for controlled voltage at an output.

### REFERENCE TO RELATED APPLICATIONS

This application claims priority of U.S. Provisional Patent Application Ser. No. 61/333,779 filed by Dr. Patrick J. McCleer on May 12, 2010 the disclosure of which is incorporated herein by reference. This application is co-pending with U.S. patent application Ser. No. 12/685,078 filed on Jan. 11, 2010 entitled MAGISTOR TECHNOLOGY, having a common assignee with the present application, the disclosure of which is incorporated herein by reference as though fully set forth.

### BACKGROUND

1. Field of the Invention

This application relates to AC waveform generation and AC batteries and more specifically to an AC battery structure employing multiple Magistor modules having a series output with pulse width modulation control of one or more of the Magistor modules for high quality waveform output and implementation as an AC battery.

2. Related Art

The power conversion system, designated “Magistor” technology herein, as disclosed in U.S. patent application Ser. No. 12/685,078 incorporates a three winding transformer using an annular or toroidal core 10 and three identical single turn windings 12, 14 and 16, designated as the α; β and γ windings, is shown in FIG. 1. With this type of construction a single turn is simply a single conductor passing through the center of the core. The total current i_{c} passing through or exciting the core is then

i_{c}=i_{α}+i_{β}+i_{γ}(Apk) (1)

where the reference directions for the α; β and γ conductor currents are shown by the direction arrows in FIG. 1. Quantities given in parentheses to the right of a symbol for a variable or a defining equation herein are the units for the variable or the net result of the equation in the MKS system of units. The total magnetic flux φ_{c} induced in the core cross section by the excitation current is given by

φ_{c}=i_{c}/R_{c}=(i_{α}+i_{β}+i_{γ})/R_{c} (Wb)

where R_{c} is the reluctance of the annular path the flux traverses in the core. The value of the path reluctance is

R_{c}=tₘ/(μAc)(H⁻¹)

where tₘ, (m) is the total effective path length, approximately equal to the circumferential length within the core at the average core diameter, μ is the magnetic permeability of the core material (H/m), and Ac (m2) is the cross sectional area of the core normal to the flux path direction. The voltage induced in the conductor in each winding path through the core center is, by Faraday's Law, equal to the time rate of change of the linked flux, or

v_{α}=v_{β}=v_{γ}=dφ_{c}/dt (V pk) (2)

An electrical equivalent circuit which satisfies the system defining equations (1) and (2) is shown in FIG. 2. The excitation inductance L_{c} (H) is simply the inverse of the path reluctance L_{c}=1/R_{c} and the circuit element IT 18 is a two winding “Ideal Transformer” with a 1:1 turns ratio. The dot convention for the ideal transformer shows the terminal at which the two winding voltages are equal and in-phase and the two winding currents are equal in magnitude but 180° out of phase. An ideal transformer requires no excitation current and functions over all frequencies, from zero frequency (DC) up.

Now consider the three winding transformer structure of FIGS. 1 and 2 with the β and γ windings connected in series. This connection scheme is shown physically in FIG. 3A and electrically in FIG. 3B. Further consider that terminals p 20, z 22 and m 24 in FIGS. 3A and 3B are connected to a common terminal or node o 26, through three bidirectional switches, designated sp 28, sz 30, and sm 32 respectively. The voltage at node o to the common connection point z between the β and γ windings, creates a reference defined as the output voltage vₒ across a terminal pair 34. The total circuit shown in FIGS. 3A and 3B is the basic Magistor converter unit system, here designated as a 1U unit or module 36. This is a completely bidirectional power conversion circuit/system. A voltage across the a winding will appear as voltage vₒ at the output terminal pair 34, dependent on which bidirectional switch is in the closed position (with the assumption that one and only one bidirectional switch is closed at any particular instant). If switch sp is closed then vₒ=v_{α}, if switch sm is closed then vₒ=−v_{α}, and if switch sz is closed then vₒ=0.

Now assume that the α terminals are connected to a square wave voltage source with peak voltage magnitude Vₓ (V) and cyclic frequency f, trace 38 in FIG. 4A. If switch sp remains closed all the time then output voltage vₒ would be equal to the input square wave voltage. If we leave switch sm closed all the time then vₒ would be the negative of the input square wave voltage. Of course if we leave switch sz closed all the time the output voltage vₒ would be zero, no matter the value of the α input voltage. If the operation of bidirectional switches sp and sm are synchronized to the times at which the input square wave voltage changes sign, the signal “synchronously” rectifies, in either a plus or minus sense, the input voltage v_{α}. For example, if at a rising zero crossing instant in the v_{α} square wave, switch sm is opened and switch sp closed, and at a falling zero crossing instant in v_{α} sp is opened and sm closed, traces 40 and 42, the input voltage v_{α} and the output voltage vₒ would be as shown in trace 44. The output voltage vₒ would be a “DC” voltage at value Vₓ (neglecting, for now, very short switching transients at the switching instants). If the switching logic is reversed for positive output, that is, sm is closed and sp is opened at rising input zero crossings, and sm is opened and sp is closed at falling input zero crossings, traces 46 and 48 of FIG. 4B, then the output voltage vₒ is a negative DC voltage with value −Vₓ, trace 50. In fact any output voltage, with quantized levels Vₓ, 0 or −Vₓ, can be formed at the output terminals by selectively and synchronously choosing which switch, sp, sz, or sm, operates at any given time. An example arbitrary waveform is shown in FIG. 5.

An expanded multi-level output transformer system is created consisting of two or more of the basic 1U modules of FIGS. 3A and 3B, by connecting the module output terminals in series and the module input terminals in parallel. For example, with two 1U modules 36 connected as shown in FIG. 6, a rudimentary, staircase or step-wise approximation to a sine wave of amplitude 2 Vₓ and fundamental frequency f=12 is created. The switching states and the resultant output waveform are shown in FIG. 7.

This series connected 1U module output scheme can be extended to any level desired. Step-wise approximation, at quantized levels of multiples of Vₓ, can be create any desired waveform, which if cyclic, has a fundamental frequency lower than approximately f=40, or at least ten quantized steps per quarter period. As described above, a system of N output series connected 1U modules, with all N input terminal connected in parallel, would allow waveform synthesis with N+1 discrete output levels (counting zero output as a separate level). But such a system would have the practical disadvantage of requiring N series on-state bidirectional switches in the circuit at any one instant, with the accompanying N forward on-state bidirectional switch voltage drops. On-state forward voltage drops for practical power level switching devices, MOSFETS and IGBTs, range from tenths of volts for low voltage MOSFETs to approximately 2 to 3 volts for high voltage IGBTs. Practical bidirectional switches as shown in FIGS. 8A and 8B, for MOSFET and IGBT constructions respectively, consist of two single switching devices 60, 62 in anti-series connection, each shunted by a bypass wheeling diode 64, so the net forward on-state drop of a bidirectional switch consists of the sum of the forward drop of one active switch and the forward drop (0.5 to 2 volts) of a wheeling diode, for a total drop of approximately 1 to 3 volts. N such drops for a N+1 level connection scheme of 1U modules would thus be quite objectionable.

The Magistor system connection scheme as describe in U.S. patent application Ser. No. 12/685,078, utilized the properties of a tertiary numbering/counting system to be able to form any decimal integer values with plus, minus, or zero additions of powers of the number 3. That is, 1=3°, 2=3¹−3°, 3=3¹, 4=3°+3¹, 5=3²−3¹−3°, 6=3²−3¹, 7=3²−3¹+3°, and so on. Negative integer values can be formed in a similar manner. A 3U Magistor module is then formed by series connecting the individual β and γ outputs of three 1U modules and parallel connecting the three input α windings. The sp, sz, and sm bidirectional switches are connected to the new p, z, and m terminals of the series connected output windings, as shown in FIGS. 9A and 9B. Thus a series connection of the output terminals of a 1U module and a 3U module, and a parallel connection of their inputs, as shown in short form in FIG. 10, could form step-wise outputs up and down to level of ±4 Vₓ (V) A sample five level approximation to a sine wave using this scheme is shown in FIG. 10, with the accompanying required switching operations. Note that this five level output could also be constructed with four 1U modules with their outputs connected in series, but in this case four on-state bidirectional switches would be conducting in series at any one time. While the 1U+3U system has only two on-state bidirectional switches conducting in series at any one time. A 9U Magistor module would have 9 series connected 1U module β and γ outputs and 9 parallel connected 1U module a windings. Applying this module in a 1U+3U+9U system, with all outputs connected in series and all inputs connected in parallel, step-wise voltages may be formed at any plus or minus multiple of Vₓ up to ±13 Vₓ. This system would have only three on-state voltage drops at any one time due to bidirectional switches, as opposed to 13 on-state drops in a binary 13 1U module system. Extensions to tertiary 27U, 81U, 243U, and so on, modules can be constructed. The required number of bidirectional switches for the tertiary system compared to a similar switching level binary can similarly be reduced. In general, a tertiary Magistor system with M sub modules of the type 1U+3U+ . . . +3(M−2)U+3(M−1)U+3MU would require 3M bidirectional switches in the system of which M would be conducting and in series at any one time. While a same level capable binary system with N=3M+3(M−1)+3(M−2)+ . . . +3+1 1U modules would require 3N bidirectional switches, of which N would be conducting and in series at any one time.

To preserve output waveform quality in a tertiary Magistor converter system, the step level magnitude Vₓ, the square wave drive voltage level at the input α terminals, could be set to a low quantized value, as an example one volt. Theoretically this level of quantization would lead to very high quality waveform synthesis. But practically there are two major problems: 1) this minimum step level change is smaller than the total series voltage drop due to the number of series connected bidirectional switches in the system, and 2) even for a household single phase, 60 Hz, 120 VAC application, the number of series 1U, 3U, 9U, 27U, and so on, modules is excessive. To reach a peak sinusoidal voltage of SQRT(2)* 120=170 (Vpk) with a 1:0 (V pk) step level at least a series connection of one each 1U, 3U, 9U, 27U, 81U modules and a partial 243U modules (at least a 170-1-3-9-27-81=49U module) would be required. This six module series set would then have six forward on-state voltage drops due to six bidirectional switches conduction at any one time.

It is therefore desirable to provide a Magistor converter system which reduces switching parasitic voltage drops by reducing the total number of series connected bi-directional switches.

### SUMMARY OF THE INVENTION

The embodiments disclosed provide a DC/AC converter which incorporates at least one Magistor module having a first sp control switch, a second sz control switch and a third sm control switch. An AC source is connected to an input of the at least one Magistor module. A switch controller connected to the first sp control switch, second sz control switch and third sm control switch to and provides pulse width modulation (PWM) activation of the switches for fine control of the voltage level at an output.

An example implementation of the embodiments disclosed provides an AC battery which employs multiple Magistor modules each having a first sp control switch, a second sz control switch and a third sm control switch and connected in series to an output. DC to AC square wave converters each fed from an associated battery are connected in parallel to inputs of the Magistor modules. A switch controller connected to the first sp control switch, second sz control switch and third sm control switch in each Magistor module provides pulse width modulation (PWM) activation of the switches for controlled voltage at the output.

The features, functions, and advantages that have been discussed can be achieved independently in various embodiments of the present invention or may be combined in yet other embodiments further details of which can be seen with reference to the following description and drawings.

### BRIEF DESCRIPTION OF THE DRAWINGS

FIG. 1 is a representation of a torroid core with three single windings;

FIG. 2 is an electrical schematic representation of the structure of FIG. 1;

FIG. 3A is a representation of Magistor 1U module;

FIG. 3B is an electrical schematic representation of the Magistor 1U module of FIG. 3A;

FIG. 4A is a trace set representing voltage input, switching control and positive voltage output for a Magistor 1U module;

FIG. 4B is a trace set representing voltage input, switching control and negative voltage output for a Magistor 1U module;

FIG. 5 is a trace set representing voltage input, switching control and voltage output for a Magistor 1U module with arbitrary synchronous rectification;

FIG. 6 is a block diagram of two Magistor 1U modules connected in series;

FIG. 7 is a trace set representing voltage input, switching control and voltage output for the two Magistor I U modules of FIG. 6 providing a step wise approximation to a sine wave;

FIG. 8A is a schematic diagram of a MOSFET bidirectional switch;

FIG. 8B is a schematic diagram of a IGBT bidirectional switch;

FIG. 9A is a physical representation of Magistor 3U module;

FIG. 9B is an electrical schematic of the Magistor 3U module of FIG. 9A;

FIG. 10 is a trace set representing voltage input, switching control and voltage output for a Magistor 1U module Magistor 3U module providing a step wise approximation to a sine wave with amplitude of 4Vx and frequency of f/12;

FIG. 11A is a block diagram of a 1U module with switching control for pulse width modulation;

FIG. 11B is a trace set for voltage input, PWM switch control and voltage output for the 1U module of FIG. 11A;

FIG. 12 is a trace set for combined stepwise and PWM sine wave approximately using a 1U+3U+1U Magistor converter;

FIG. 13 is a block diagram of the 1U+3U+1U Magistor converter;

FIG. 14 is a block diagram of a 1U+3U+1U Magistor converter with parallel DC input systems;

FIG. 15 is a block diagram of a 1U+3U+1U Magistor converter with parallel battery DC input systems for an AC battery system;

FIGS. 16A-D are block diagrams of connection schemes for the AC battery system of FIG. 15.

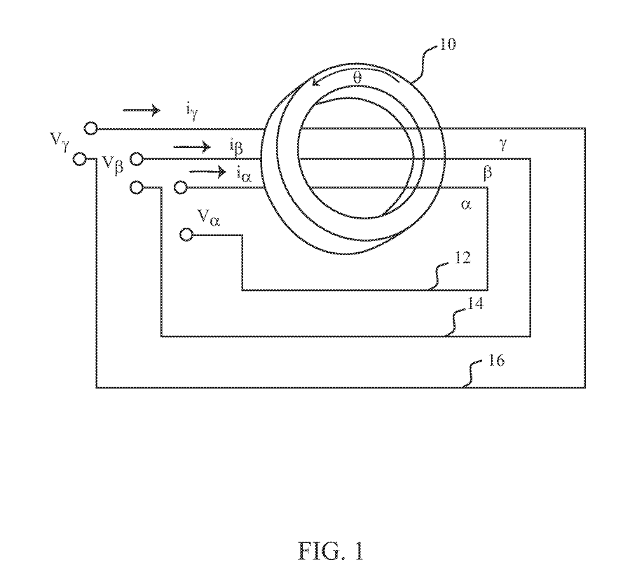

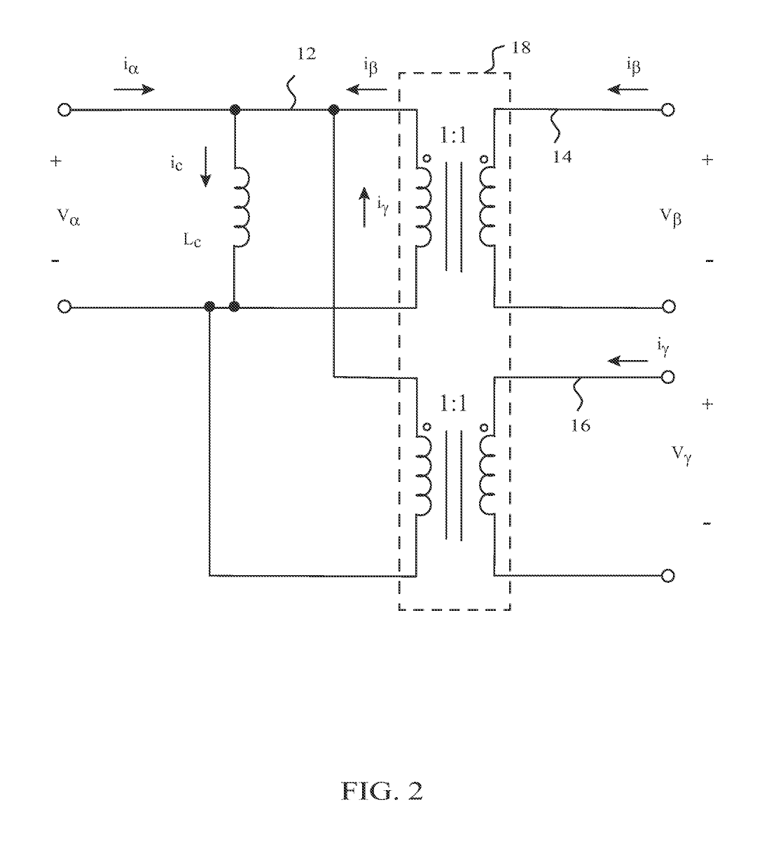

### DETAILED DESCRIPTION OF THE INVENTION

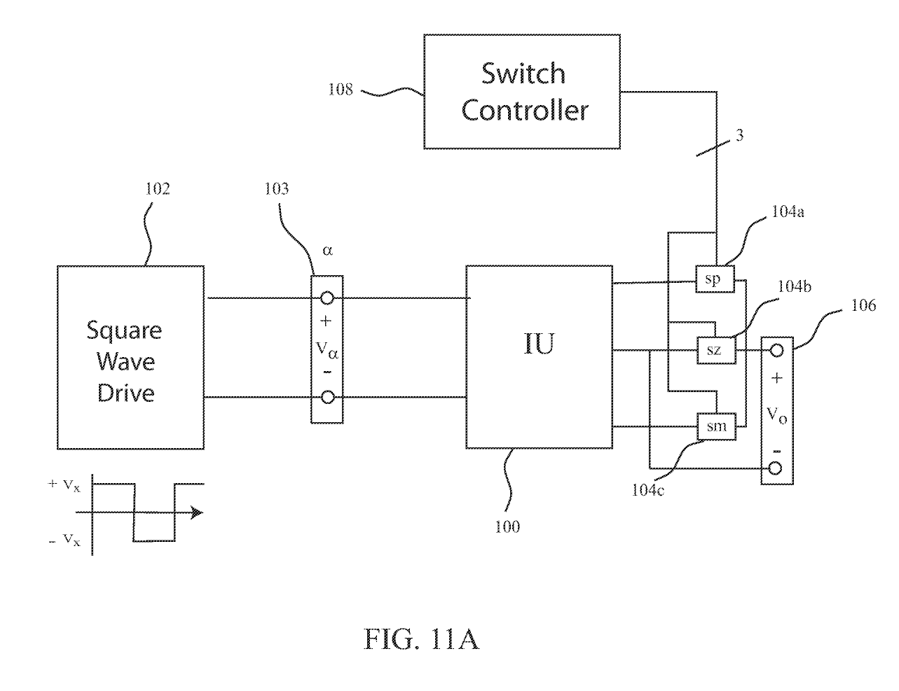

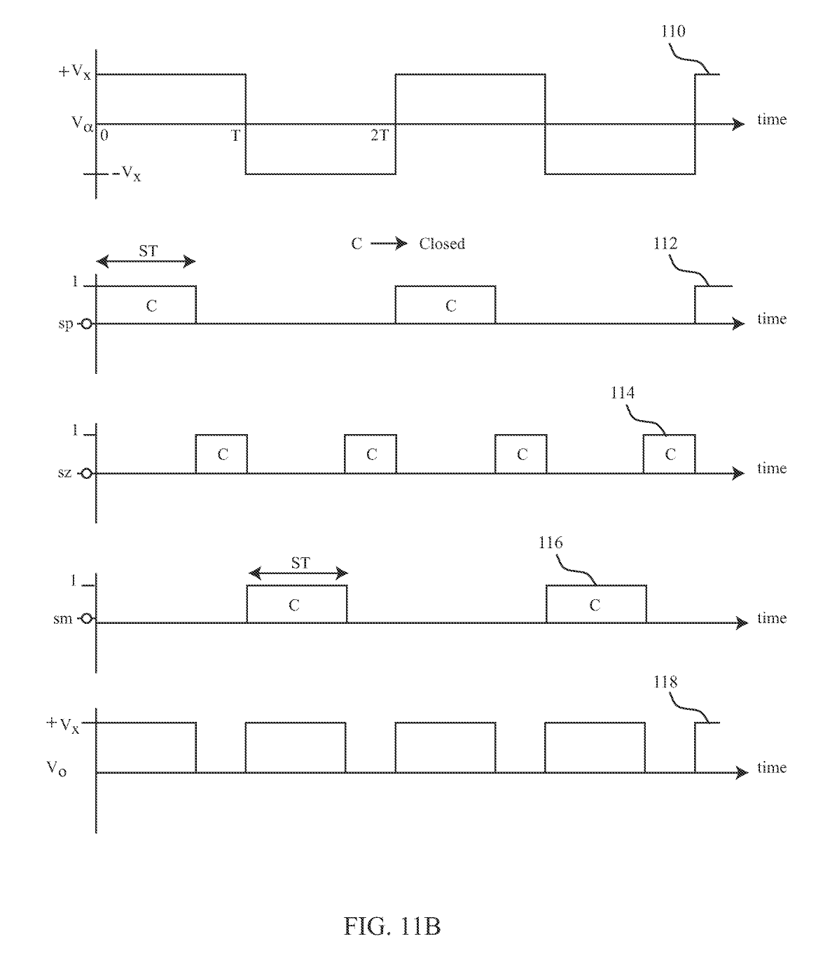

Referring to FIGS. 11A and 11B an improved Magistor converter system utilizing pulse width modulation (PWM) of one Magistor 1U module is demonstrated. As originally conceived the Magistor converter system had no need of PWM operation due to the fact that the envisioned step-wise output waveform synthesis technique would use step voltage increments small enough to insure the desired waveform quality. However, minimum step increments on the order of one volt lead to impractical circuit realizations with excessive numbers of required bidirectional switching elements. PWM operation of a basic Magistor 1U module 100 having a square wave drive 102 connected to a input 103 and control switches sp 104a, sz 104b and sm 104c controlling output 106 as shown in FIG. 11A is achieved with a switch controller 108 connected to the switches providing waveforms for PWM operation shown in FIG. 11B with trace 110 of voltage vo output from the square wave drive and operation of normally open switches sp, sz and sm shown in traces 112, 114 and 116 respectively. If the α terminal input voltage v_{α} is again a square wave with peak voltage Vₓ, an “average” voltage vₒ trace 118 is formed at the output terminal equal to ±δVₓ, where δ is a switching duty cycle with value 0<=δ<=1.0, by utilizing the sz switch in conjunction with the sp and sm switches. In a leading edge PWM mode (referring to relative positions within a square wave half cycle, of time extent T), for average plus output voltage, sp is closed and sz opened at the rising zero crossing of v_{α} (it is assumed that switch sz was closed prior to the rising zero crossing instant). At time δT after the rising zero crossing event sz is closed and sp opened. Similarly, at a falling zero crossing of v_{α} sm is closed and sz opened, and δT later sm is opened and sz closed. On the average the output voltage vₒ is then equal to +δVₓ. To obtain a −δVₓ average output the sp and sin operations are reversed from those defined for the +δVₓ output. Thus, dependent on the degree of time difference controllability of the bidirectional switch drive mechanisms (how fine the control of different δT times can be) an output voltage is attainable at nearly any level between ±Vₓ. Through use of PWM operation there is no need to limit Vₓ to small voltage levels to obtain good waveform quality. Vₓ could in fact be raised to the peak voltage required at the output terminals of the entire system, and the entire Magistor converter system could be formed with a single high voltage 1U module.

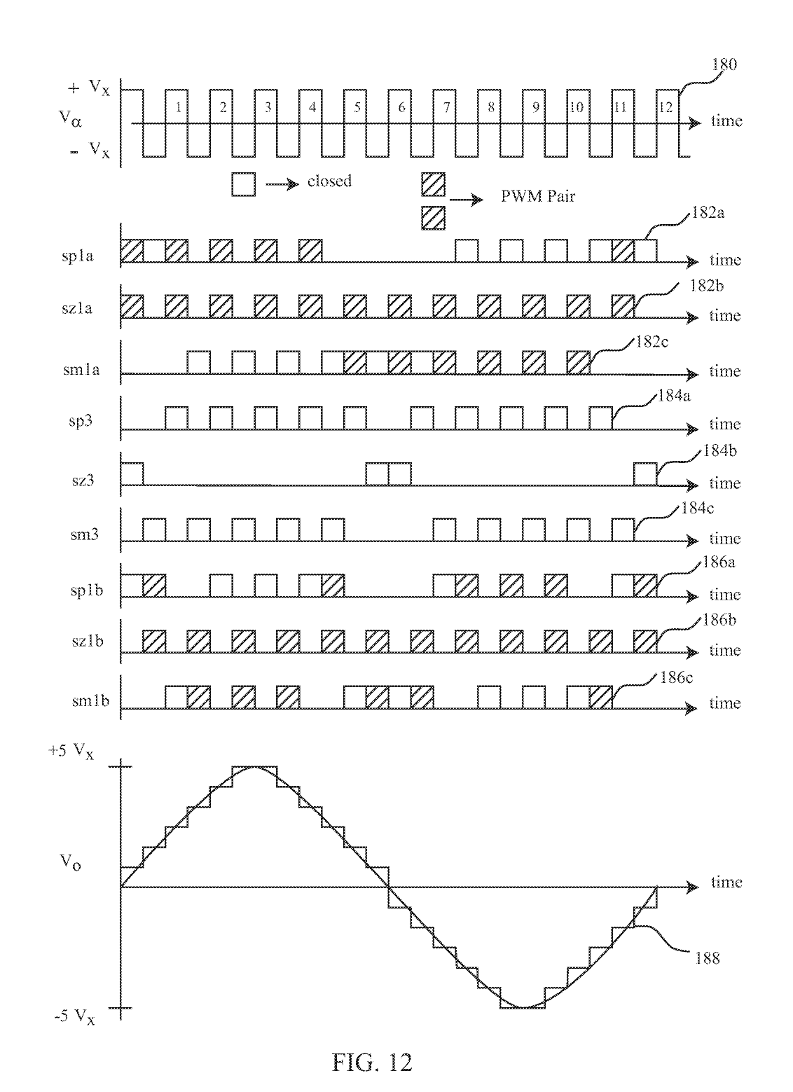

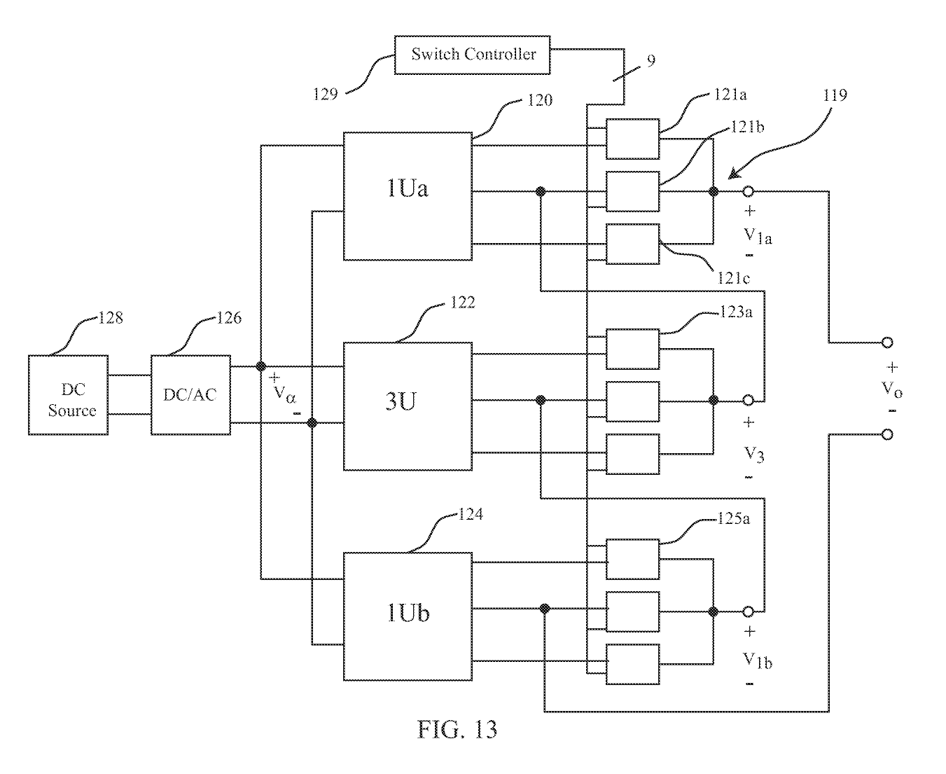

However, for an alternative embodiment, the quality of the output waveform, using fixed frequency PWM, can also be improved (lower total harmonic distortion) if the PWM output is limited to only a portion of the output, with the remainder made up of discrete step-wise levels. Therefore PWM operation can be limited within a Magistor converter system to a single 1U module. For example, for a 1U+3U system any average output value between ±4 Vₓ may be attained, while for a 1U+3U+9U+1U system any average output value between ±14 Vₓ can be attained, and so on. In yet another alternative embodiment, the PWM operation duty between the two Magistor 1U modules may be split to share the extra switching losses due to PWM operation. An example of PWM operation for this second alternative embodiment is shown in FIG. 12 for a Magistor converter 119 having connected in series a Magistor 1U module, a Magistor 3U module and a Magistor 1U module (a 1U+3U+1U system) shown in FIG. 13 with a sine wave output of peak magnitude 5 Vₓ. In FIG. 13 the 1U+3U+1U system incorporates a first Magistor module 1Ua 120, a second module 3U 122 and a third module 1Ub 124. The potential quality of this waveform far exceeds that of a fixed level, non-PWM 1U+3U+1U system. Bidirectional switches sp1a 121a, sz1a 121b and sm1a 121c are provided for control of module 1Ua 120. Similarly, bidirectional switches sp3 123a, sz3 123b and sm3 123c are provided for control of module 3U 122 and bidirectional switches s1b 125a, sz1b 125b and sm1b 125c are provided for control of module 1Ub 124.

The v_{α} input windings are fed by an AC source incorporating, for example, a DC to AC square wave converter 126, such as a full bridge converter, fed from a DC source 128 with voltage Vₓ (VDC). A switch controller 129 is provided for control of the internal bidirectional switches. With the v_{α} input shown in trace 180 of FIG. 12, control of the switches as shown in FIG. 12 by traces 182a for sp1a, 182b for sz1a, 182c sm1a, 184a for sp3, 184b for sz3 184c for sm3, 186a for sp1b, 186b for sz1b and 186c for sm1b (where cross hatching shows PWM pairs for the switching) provide a highly refined approximately of a sinewave output as shown by trace 188.

With this embodiment there is an incentive to raise Vₓ and lower the number of required higher order U modules for a given required AC output voltage. The fewer the number of higher order U modules (such as 3U, 9U, 27U, etc) the fewer the number of required bidirectional switches. On the other hand, if the DC bus voltage Vₓ is raised too high, there will be safety concerns, particularly if the DC bus is fed from a battery bank, with high voltage, potentially at lethal levels, present even during the converter off-state.

A Magistor converter system is suitable for a large range of applications when provided with electrically paralleled subsystems. For the generic 1U+3U+1U Magistor converter system shown in FIG. 13, to increase the power capability of the system but also keep the output AC voltage level the same as in the base system alternative embodiments may simply increase the power capability of each component in the system shown. This would also require increasing the DC feed capability at the DC terminals. If this DC feed is due to batteries this requires using higher current capability batteries or paralleling cells or stacks of lesser rated battery packs. However, paralleling batteries may be limited due to current sharing problems. As an alternative, the entire system shown may be duplicated, as many times as needed to attain the required power capability, and the systems connected together electrically parallel at the AC output vₒ terminals. This method avoids the issues of paralleling uncontrolled DC sources, but requires duplication of potentially the most expensive components in the entire system, the collection of bidirectional switches and their required high speed control system. As yet another alternative, the power capability of each component in the system shown except the DC source and the connected DC/AC bidirectional converter may be increased. Rather than parallel DC sources, DC sources and DC/AC converters are duplicated as required and assembled in parallel at their AC terminals.

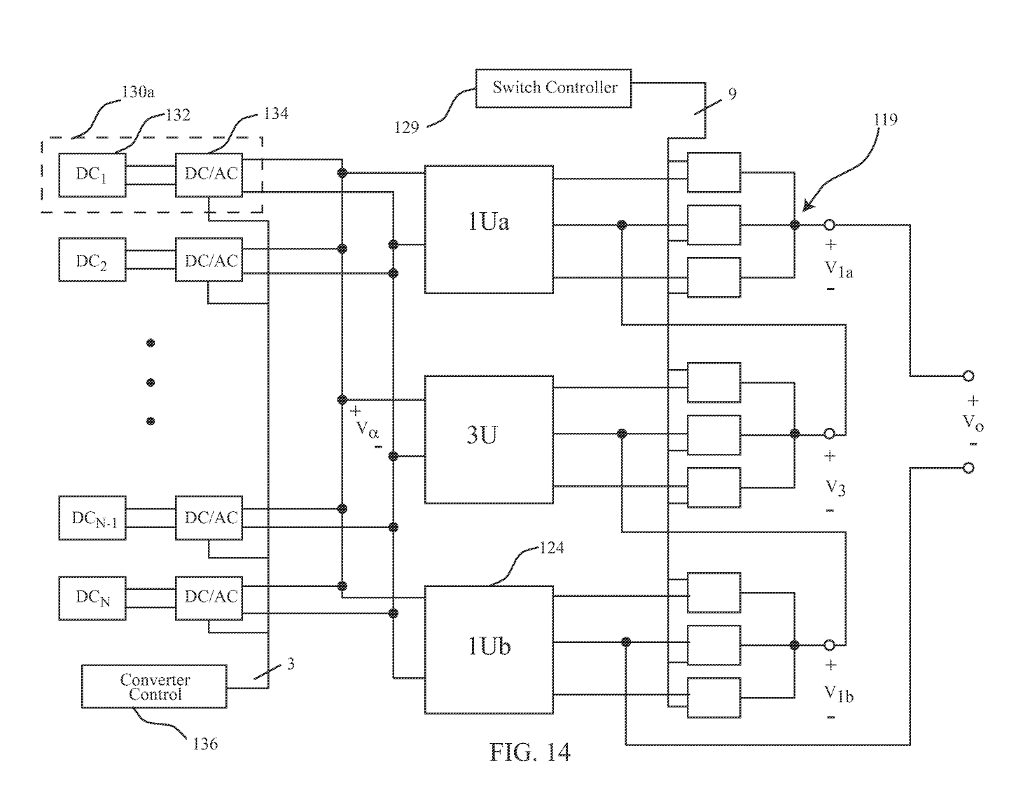

This embodiment is shown in FIG. 14. The control of parallel AC sources, 130a-130n, each having a DC source 132 and a DC/AC bidirectional converter 134 such as a MOSFET, full bridge, square wave drive circuit, connected at the v_{α} terminals of the Magistor converter 119 is accomplished by current regulation at the DC terminals of the individual DC/AC converters with a converter controller 136 to maintain a constant, common, output square-wave AC effective feed/terminal voltage v_{α}. No duplication of the high speed control of the internal bidirectional switches provided by switch controller 129 is required. There is also a reliability benefit to this proposed configuration. Should any DC source fail or degrade sufficiently in operation it can be simply be electrically removed from the system by turning off the associated DC/AC converter with the converter controller. The total system power capability/rating is then lowered, but operation at least at partial output is assured. DC sources could even be removed while the remaining system is still operating, a “hot swap” capability. Different types or ratings of DC sources, such as different types of batteries, or even ultra-capacitors may be mixed. Current regulation control of the individual DC/AC converters by the converter controller maintains each source at its desired operating point.

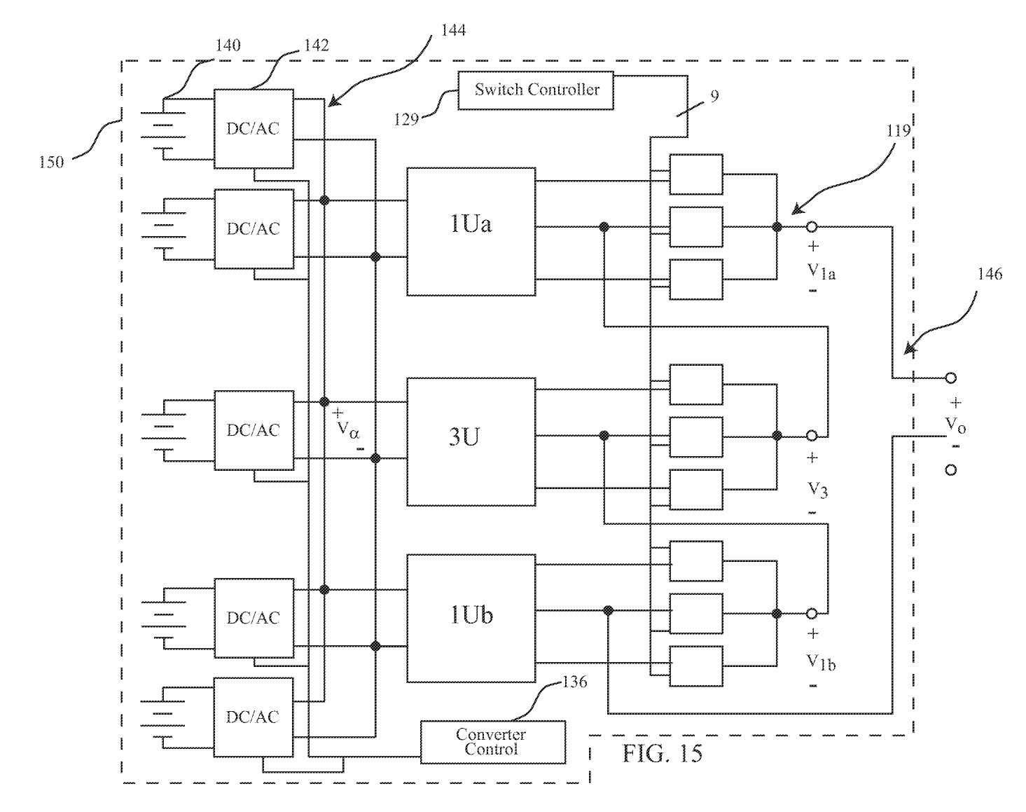

An AC battery may be provided using the described parallel DC source system. The Magistor converter with paralleled DC sources and associated DC/AC converters of FIG. 14 is shown in FIG. 15 with the specific use of DC batteries 140 as the DC sources to supply DC/AC converters 142. For an exemplary embodiment each battery may comprise 12 series Lithium Ion (Li-Ion) cells such as cells produced by A123 Systems of Waltham, Mass. having part numbers APR18650 (1.1Ahr), ANR266250 (2.3Ahr), AHR32113 (4.4Ahr) or the higher energy AMP20M1HD-A (20Ahr). There are five identical battery DC/AC converter combinations, electrically paralleled at the AC low voltage terminals 144, the α terminals of the 1U+3U+1U Magistor converter 119. A five unit system is shown as an example for this embodiment but is not limiting as to the number of parallel DC source/DC/AC converter pairs which may be employed. The rating of this combined package is approximately equal to five times the rating of an individual battery pack. For example, if the thermal rating of an individual battery pack is 1 kW then the entire system would be sized to have a total thermal rating of approximately 5 kW.

The terminology “AC Battery” is used to describe this entire system, since the system behaves as a re-chargeable electrical energy storage device at the high voltage AC terminals 146, with a two wire single phase AC connection input/output.

For household and consumer application in the U.S. the high voltage two wire AC connection would be at 60 Hz, 120 VAC (all sinusoidal voltage magnitudes disclosed herein unless otherwise defined imply a root-mean-square (rms) value). When AC power flows into an AC battery at the AC terminals, it is converted to controlled DC power flow; whereupon it charges batteries connected to the DC terminals of the DC/AC converter subsystems. When power is required in the network connected to the AC terminals, for example to support a temporarily weak AC system, or even fully support a local AC system during a grid outage, or to feed a stand alone AC load, the power flow process is reversed in direction, but with the same effective level of power flow control. This control, both during charge or discharge of the batteries, is achieved by current regulation in the DC/AC converters by the converter controller and amplitude and relative phase angle control (i.e. “vector” control, as accomplished in modern AC motor drives) of the output AC voltage at the AC terminals with respect to the system or grid AC voltage at the point of system/grid connection.

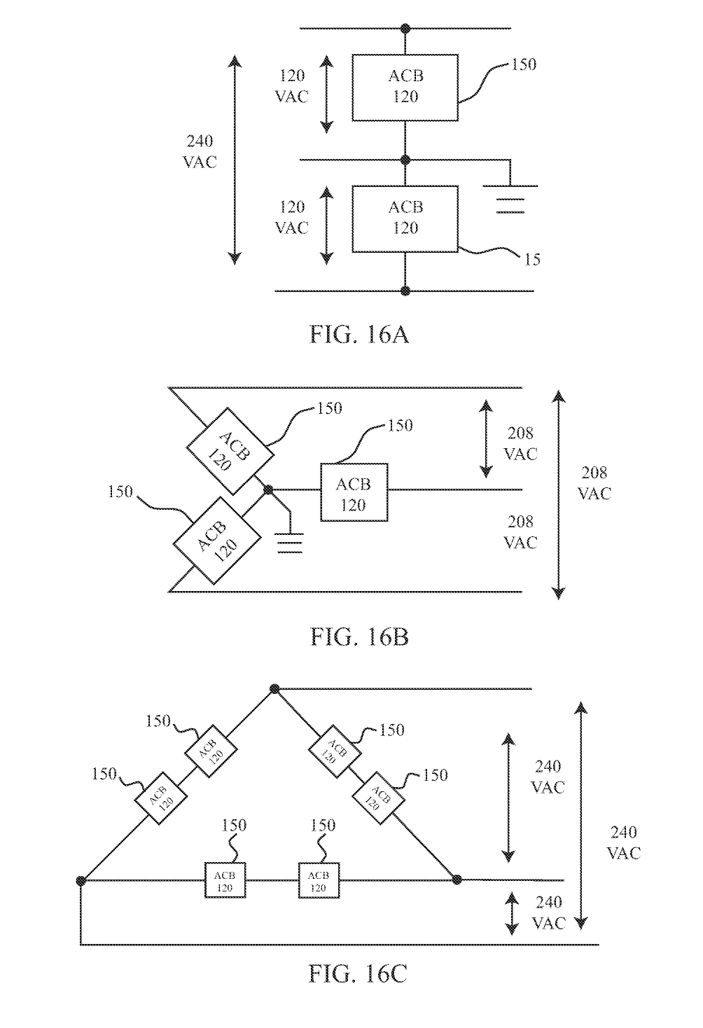

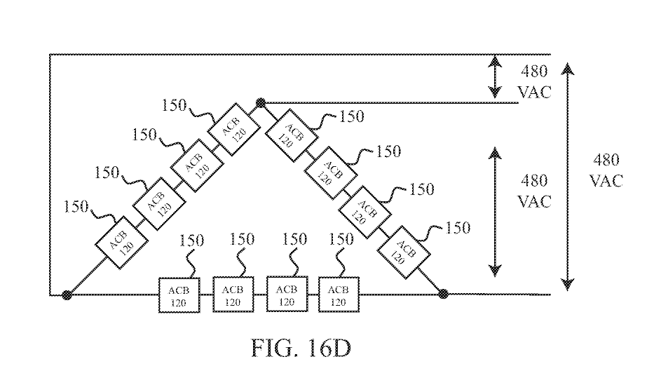

Beyond the single phase 60 Hz 120 VAC AC battery, higher voltage higher power rated AC battery systems can be formed by various combinations of multiple 120 VAC building blocks created by Magistor AC Battery systems 150 as shown in FIG. 15. Two single phase 120 VAC systems 150, synchronized and series connected with the common connection point grounded would form a three wire 240/120 VAC Edison system, as shown in FIG. 16A. Three 120 VAC single phase systems synchronized but phase displaced from each other by 120° and connected in a wye configuration would form a commercial/industrial 208 VAC 1-1 3-phase system, shown in FIG. 16B. Three 240 VAC systems (two 120 VAC synchronized and in-phase systems connected in series), all synchronized but phase displaced by 120° from each other, connected in a delta configuration would form an industrial 240 VAC 1-1 3-phase system, shown in FIG. 16C. And three 480 VAC systems (four 120 VAC single phase systems, synchronized and all in-phase, connected in series) all synchronized but phase displaced from each other by 120°, would form an industrial 480 VAC 1-1 3-phase system, shown in FIG. 16. Further extensions to even high voltage systems should be obvious. And to increase the power rating or capability of any of these building block system AC batteries, parallel connection of multiple 120 VAC systems, all synchronized and in-phase, at each 120 VAC subsystem station may be accomplished. Thus a common design Magistor AC Battery system 150, such as that shown in FIG. 15, can be utilized in a great many applications, without power or voltage limitations. This overall modularity of the system design will lead to low production costs due to mass production of identical components.

For the specific Magistor AC battery system 150 shown in FIG. 15 with a 120 VAC AC side rating the peak DC voltage Vₓ at the DC terminals of the DC/AC converter subsystem (assuming a full bridge converter circuit) would be sqrt(2)x 120/5=33.9 (VDC). The use of Li-ion batteries, with individual cell voltages of approximately 3.0 VDC at heavy discharge, requires a series string of at least 11 cells (12 being a safer number) for each battery pack.

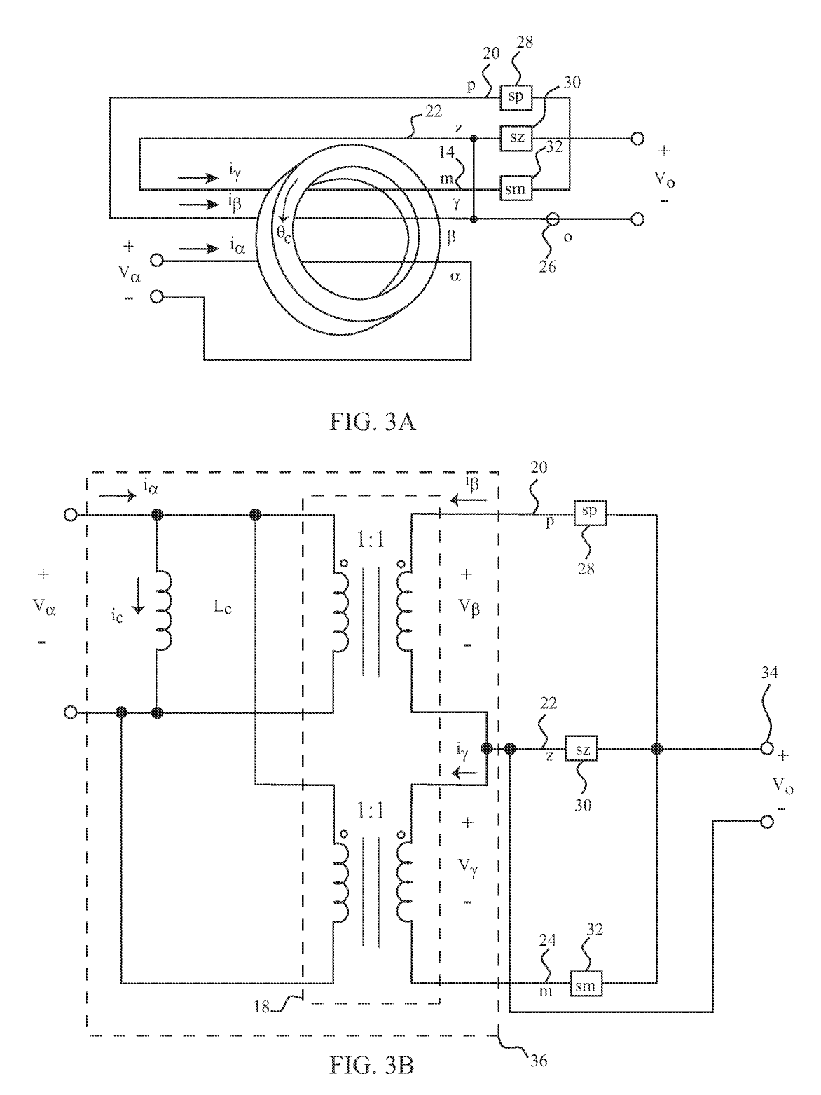

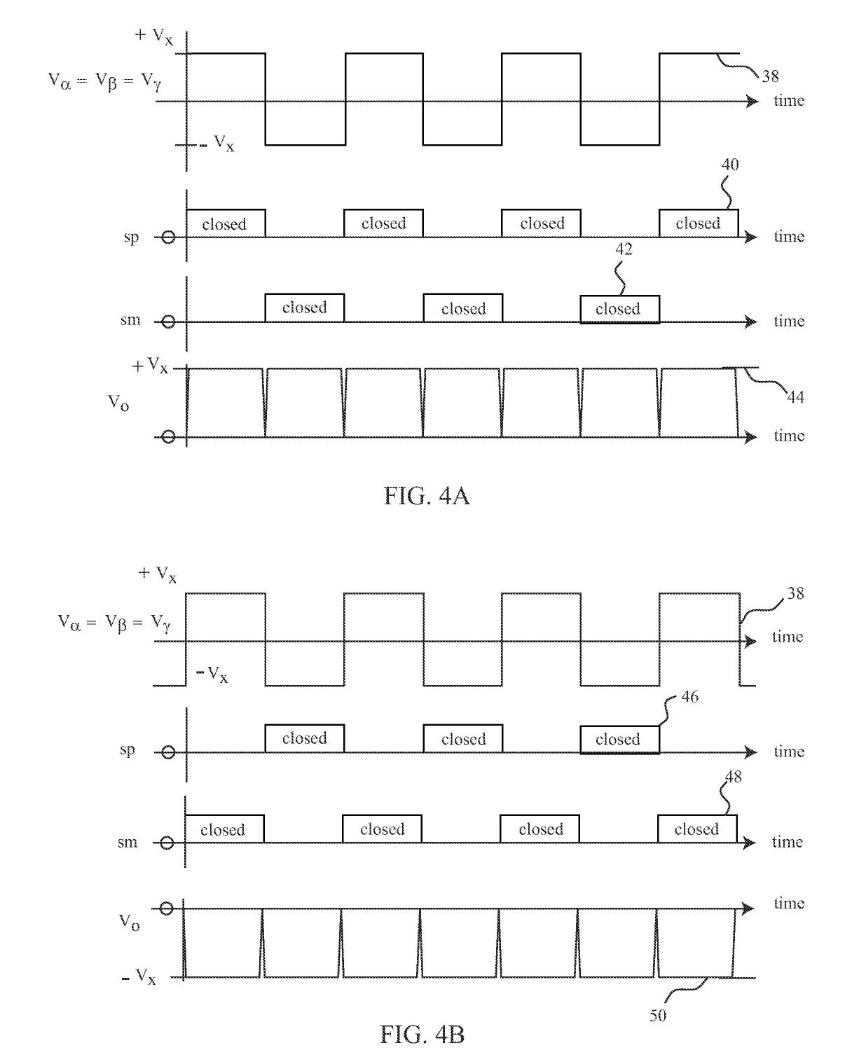

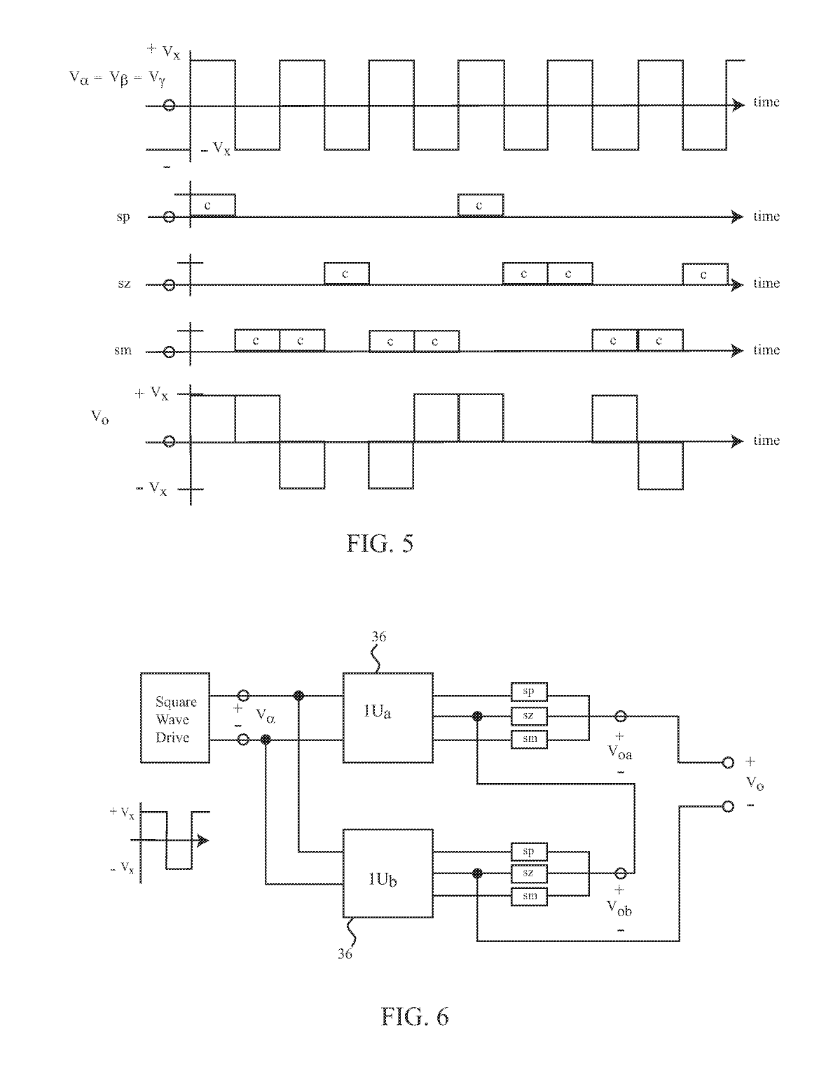

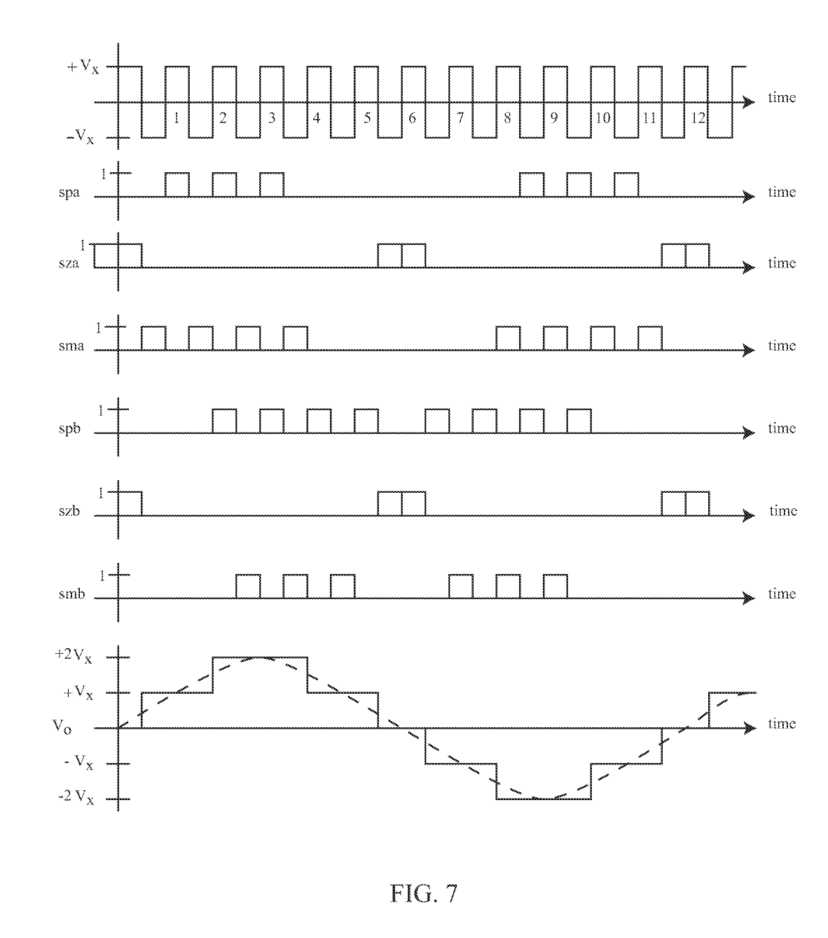

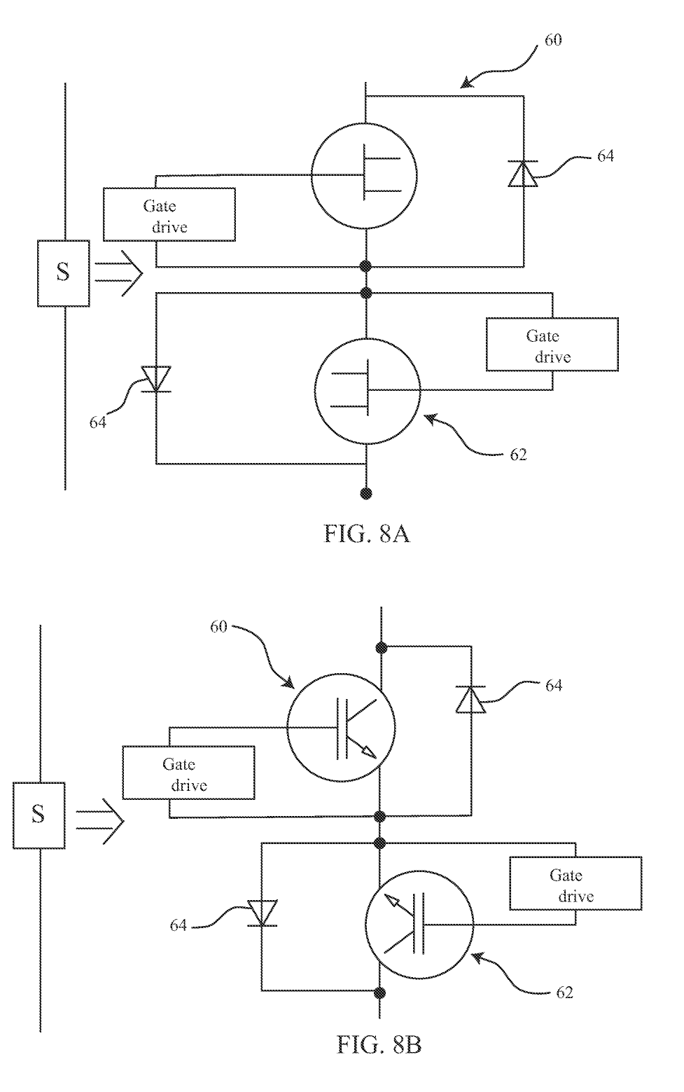

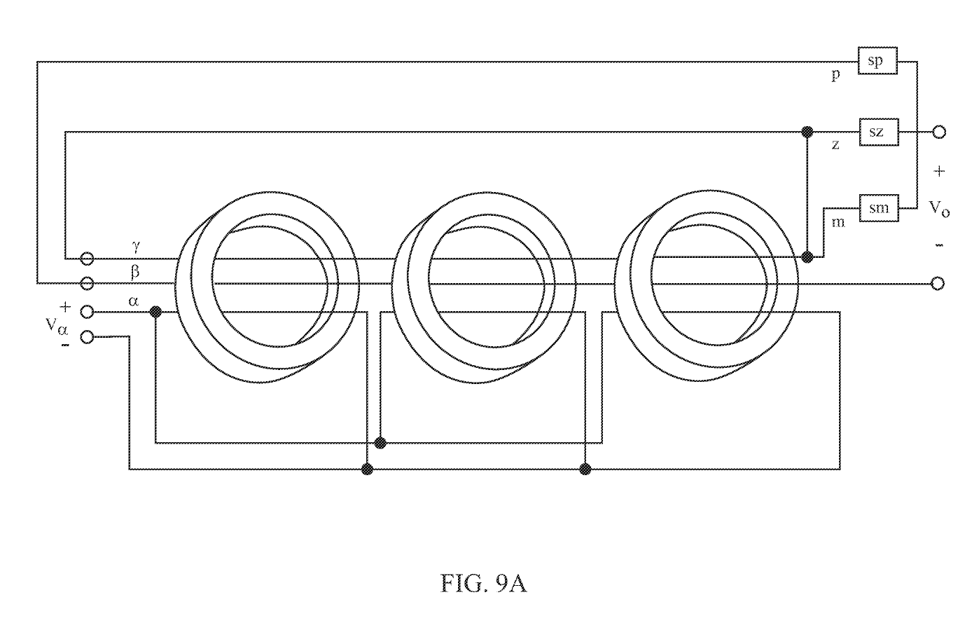

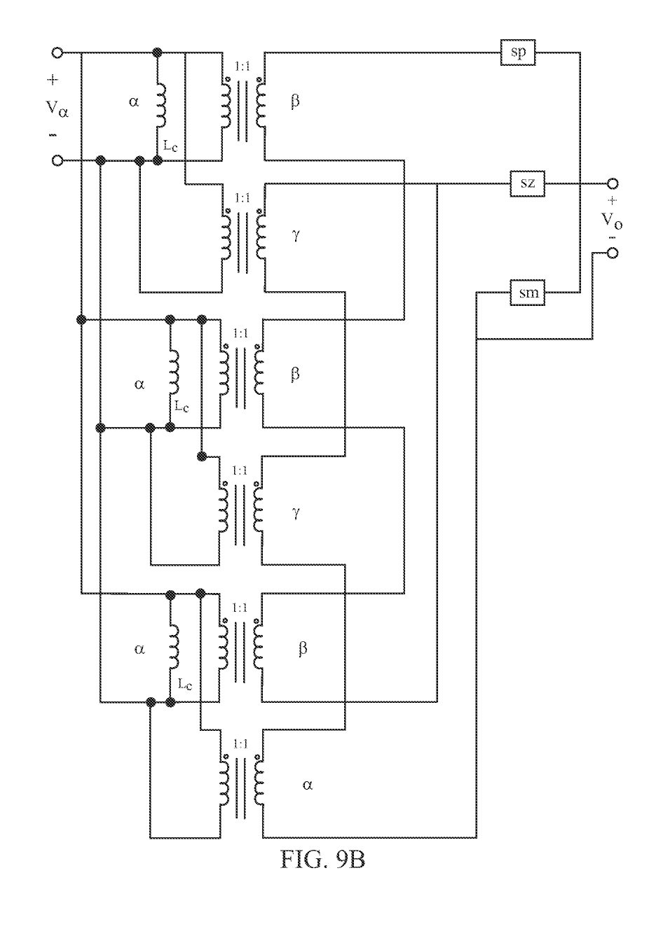

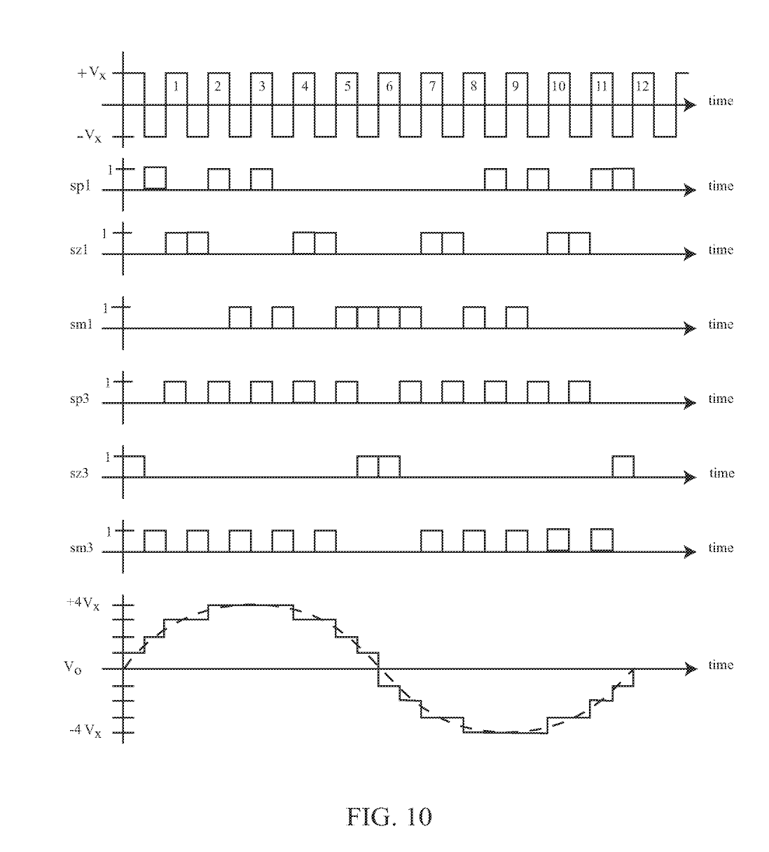

For the embodiments shown each DC/AC converter is based on a MOSFET, full bridge, square wave drive circuit. The 1U and 3U transformer subsystems are as depicted in FIGS. 3 and 9, respectively, with each 1U core structure sized to support at least 40 to 50 peak volts of square wave excitation/drive at a switching frequency in the 20 to 50 kHz range. For example embodiments, the bidirectional switches are MOSFETs for the 1U modules and IGBTs or MOSFETs for the 3U module.

Although the example embodiments described above for the AC battery concept have all been for fixed frequency, fixed voltage systems, the AC battery system is not limited in this regard, nor to this application area. Step-wise and PWM waveform synthesis is inherently variable voltage and variable frequency capable. The controlled AC output of an AC battery system, particularly when connected in three (or higher) phase configurations can be employed to drive and control AC motors and alternators in a straightforward manner. For example, in an electric vehicle, or hybrid electric vehicle, with AC battery energy storage, there is no need for dedicated power electronics for traction motor control. Use of high speed digital processors in the switch controllers in the AC battery systems, which control the AC bidirectional switches, could easily handle the extra computational loading required to control the motor output. When an electric vehicle is parked, the AC battery module AC connections can easily be reconfigured to match the nature of the near-by AC grid (single phase 120 or 240 VAC, three phase 208, 240 or 480 VAC). The internal AC battery processors can then manage the battery charging or discharging (if the vehicle is feeding or supporting the local grid). No additional or outside power electronic controllers would be required.

Having now described various embodiments of the invention in detail as required by the patent statutes, those skilled in the art will recognize modifications and substitutions to the specific embodiments disclosed herein. Such modifications are within the scope and intent of the present invention as defined in the following claims.

What is claimed is:

1. A DC/AC converter comprising:
at least one Magistor module having a first sp control switch, a second sz control switch and a third sm control switch;
an AC source connected to an input of the at least one Magistor module; and,
a switch controller connected to and providing pulse width modulation (PWM) activation of the first sp control switch, second sz control switch and third sm control switch of the at least one Magistor module for controlled voltage at an output.

2. The DC/AC converter as defined in claim 1 wherein the at least one Magistor module comprises a first 1U Magistor module, a 3U Magistor module and a second 1U Magistor module connected in parallel to the AC source and in series to the output.

3. The DC/AC converter as defined in claim 2 wherein the AC source comprises a DC to AC square wave converter fed from a DC source.

4. The DC/AC converter as defined in claim 3 wherein the DC to AC square wave converter comprises a fill bridge converter.

5. The DC/AC converter as defined in claim 2 wherein the AC source comprises a plurality of DC to AC square wave converters each led from an associated DC source.

6. The DC/AC converter as defined in claim 5 wherein the associated DC sources are batteries.

7. The DC/AC converter as defined in claim 6 where each battery comprises a second plurality of lithium ion cells.

8. The DC/AC converter as defined in claim 5 further comprising a converter controller for current regulation of the DC/AC converters.

9. An AC battery comprising:
a plurality of Magistor modules each having a first sp control switch, a second sz control switch and a third sm control switch, said Magistor modules connected in series to an output;
a second plurality of DC to AC square wave converters each fed from an associated battery connected in parallel to inputs of the plurality of Magistor modules;
a switch controller connected to and providing pulse width modulation (PWM) activation of the first sp control switch, second sz control switch and third sm control switch in each Magistor module for controlled voltage at the output.

10. The AC battery as defined in claim 9 further comprising a converter controller for current regulation of the DC/AC converters.

11. The AC battery as defined in claim 9 wherein the plurality of Magistor modules comprises a first 1U module, a 3U module and a second 1U module connected in series.

12. A method for AC wave form generation with a plurality of Magistor modules each having a first sp control switch, a second sz control switch and a third sm control switch, said Magistor modules connected in series to an output comprising:
controlling at least one of the plurality of Magistor modules for pulse width modulation of the first sp control switch, a second sz control switch and a third sm control switch; and,
controlling at least a second one of the plurality of Magistor modules for discrete step wise voltage change.

13. The method for AC wave form generation as defined in claim 12 wherein the plurality of Magistor modules comprises a first 1U module, a 3U module and a second 1U module and the step of controlling at least one of the plurality of Magistor modules for pulse width modulation comprises controlling the first sp control switch, a second sz control switch and a third sm control switch of the first and second 1U modules for pulse width modulation and the at least second one of the plurality Magistor modules comprises the 3U module.

14. The method for AC wave form generation as defined in claim 12 wherein the plurality of Magistor modules has a parallel input from a second plurality of AC sources having DC to AC square wave converters each fed from an associated battery and further comprising controlling the square wave converters for regulating current.

15. The method for AC wave form generation as defined in claim 14 wherein regulating current further comprises disconnection of selected square wave converters.
